(19) United States
(12) Patent Application Publication
(10) Pub. No.: US 2012/0124855 A1
(43) Pub. Date: May 24, 2012

(54) METHOD FOR REDUCING THE MOISTURE OF AN INSULATION-COATED WINDING AND A SPRAYING DEVICE FOR REDUCING MOISTURE

(75) Inventor: Jan-Rainer Sicham, Fuerth - Burgfarrnbach (DE)

(73) Assignee: SIEMENS AKTIENGESELLSCHAFT, MUENCHEN (DE)

(21) Appl. No.: 13/387,811

(22) PCT Filed: Jul. 29, 2009
(86) PCT No.: PCT/EP09/05699

§ 371 Date: Feb. 8, 2012

(51) Int. Cl. F26B 3/00; F26B 19/00

(52) U.S. Cl. 34/357; 34/60

(57) ABSTRACT

A method for reducing the moisture of at least one winding surrounded by an insulating layer in a container, includes heating the winding to a specifiable temperature by a low-frequency current. A spraying device includes a nozzle for reducing the moisture of at least one winding surrounded by an insulating layer in a container. A rod element is used as a part of the spraying device so that it is possible to point the nozzle of the spraying device directly at a winding and an insulating layer. A gentle and effective drying of the winding having an insulating layer is provided by combining an inner heating of the winding by a low-frequency current and the spraying of a rod-shaped spraying device directly at the winding.

Method for reducing the moisture of an insulation-coated winding, and a spraying device for reducing moisture.

The invention relates to a method for reducing the moisture of at least one winding, surrounded by an insulating layer, in a container, wherein the winding is heated to a pre-determinable temperature by means of a low-frequency current. The invention further relates to a spraying device having a nozzle for reducing the moisture of at least one winding, surrounded by an insulating layer, in a container.

Moisture forms in the insulating layer of a winding of an oil-insulated transformer in the course of the operating life as a result of chemical and thermal-physical processes. As well as this moisture formed inside a transformer, moisture passes via the expansion vessel, which is constantly in contact with the outside air, into the oil circuit of an oil-insulated transformer.

The moisture thus formed and retained inside the insulating layer of the winding compromises the operational safety of oil-insulated transformers as the moisture reduces the insulating capability of the insulating layer and at the same time speeds up the ageing process of the insulating layer.

For this reason, the windings and insulating layers need to be dried at regular intervals as part of servicing and repair work. Owing to the large structural size and the requirement for a high degree of availability for the transformers, many repair and service tasks can only be carried out directly on site on the oil-insulated transformer. The so-called vapor phase method requires, for example, a corresponding drying oven in which a previously dismantled winding with an insulating layer must be placed. After drying, the winding with the insulating layer must be replaced in the transformer, the insulated fastened connections must be re-tensioned, and the windings re-pressed because of changes in their length. A possible alternative method is introducing hot air into the container of the transformer, wherein no cleaning of the transformer takes place hereby and local overheated areas and hence damage to the insulating layer can occur as a result of heat flow and convection processes. A disadvantage of this hot air method is the relatively slow drying process, as well as the disadvantage that the progress and quality of the drying cannot be checked.

In the so-called oil spraying method, a heated mist of oil droplets is generated via spray nozzles arranged on the container. In this method too, the transformer must be disconnected from the power grid before it can be dried. The insulating oil is first pumped out of the tank of the transformer. The cover is then opened and the active part dismantled. This is necessary in order to make the openings for the spray nozzles. The spray nozzles are adapted to fit and the special nozzle openings are made in the cover and the tank, usually welded specifically for this purpose. After the preparation measures of the oil spraying method have been carried out, the active part is replaced in the tank and the transformer is closed. A controlled vacuum pump is connected to the transformer tank. The spray nozzles, as well as the tank of the transformer, are joined to an oil processing unit. The oil processing unit must include oil pumps, filters, a heater, and a degassing tank. Insulating oil is then poured in to a level of approximately 40 cm above the base plate of the tank.

The oil circulation process is started after these preparatory operations. The insulating oil that is situated in the bottom part of the tank is sucked into the oil processing unit, filtered, heated, degassed and forced back into the tank space of the transformer via the nozzles. The processed heat oil is sprayed from the nozzles onto the windings. It flows over them and heats them up. The oil drips from the windings and collects again in the bottom area of the tank. It washes around the bottom yoke of the core and also heats up the core. After the active part has reached a temperature of 60° C. to 80° C., a vacuum pump is switched on and the moisture in the steam is sucked out. As long as a cold trap is incorporated into the vacuum cycle, the success of the process can be monitored relatively well. The oil spraying process continues until it can be discerned that no more moisture can be sucked out of the windings by the vacuum pumps.

DE 195 01 323 C2 thus describes a method for drying the solid insulation of a transformer arranged in an electrical system. The intention is to dry the solid insulation by means of a precisely established sequence of very different temperature distributions inside a transformer.

Likewise, the drying of a winding and an insulating layer of a transformer is carried out in such a way that a low-frequency current inside the winding generates a defined temperature. This so-called low-frequency heating (LFH) is also known as hard drying as there is a risk of overheating and localized burning of the insulating layer as part of this drying method. Moreover, there is no circulation at all of liquid about the windings and insulating layers so that the active part is not cleaned and the windings need to be re-pressed because of the changes in the lengths of the winding that are caused by the hard drying.

The LFH method makes use of the technical fact that windings through which current flows heat up as a result of their ohmic resistance. The transformer to be dried is short-circuited on the low-voltage side. The LFH system is connected on the high-voltage side. A low-frequency current up to 10 Hz is fed into the high-voltage windings by the LFH system. These high-voltage windings heat up directly as a result of the ohmic resistance. The magnetized core of the transformer is excited by the low-frequency current and likewise heats up. It transmits the power to the low-voltage side of the transformer. Current flow occurs in the short-circuited windings of the low-voltage side and heats up these windings. The heating of the windings and the core effects a heating of the whole active part from inside, including the insulating material which is in direct contact. The moisture is sucked out by a vacuum pump connected to the tank of the transformer.

Before a transformer can be dried using the LFH method, the transformer must be disconnected from the power grid. The insulating oil is pumped out. Temperature sensors are attached to the tank and the active part, and the tank of the transformer is then connected to a vacuum pump set via an electrically adjustable valve group. The low-voltage side is short-circuited and the high-voltage side is connected to the LFH system.

The LFH method is started after these preparatory operations have been completed. It consists of a sequence of heating and vacuum phases. The duration and intensity of the individual current and hence heating phases are dependent on algorithms that were set by the manufacturer of the LFH system. The current phases are controlled by an SPS control system, wherein the signals from the attached sensors, as well as the results of automatic measurements that are part of the LFH method, are included in the computation. The user can intervene in the LFH method and customize it. The evaporated moisture is extracted by the vacuum pump. The success of the drying process can be measured by technology when a cold trap is integrated into the vacuum cycle.

On completion of the LFH method, the mechanical connections that are produced from an insulating material must be re-tensioned on the active part. Usually the windings must be re-pressed too. To do this, the active part of the transformer must be lifted out of the tank. This is only possible when the cover is taken off the tank. After the tensioning and pressing, the active part is replaced and the transformer closed. A final vacuum process is started. The insulating oil is then poured in and circulated. The working steps to resume operation can then begin.

WO2007/103145 A1 thus describes a low-frequency heating system. EP 1 253 389 B1 moreover discloses a method for drying an active part and a device for carrying out this method using the LFH method.

A disadvantage of all the methods from the prior art is that there is no targeted and controlled drying of the winding and the insulating layer of an oil-insulated transformer.

The object of the present invention is therefore to provide a method for reducing moisture that makes it possible to reduce on site simply and effectively the moisture in the insulating layer and the winding in a container.

The object is achieved by a method according to the features of patent claim 1. The object is moreover achieved by a spraying device according to the features of patent claim 7. The object is achieved according to the invention by a rod element with a nozzle being arranged in at least one opening of the container as a spraying device, wherein the nozzle of the spraying device can be pointed at the winding and a heated oil is sprayed via the nozzle of the spraying device onto the winding. As a result, the winding is completely and gently dried by the combined heating by means of the low-frequency current inside the winding and by means of the oil from the spraying device, sprayed onto the winding.

In contrast to the simple exclusive oil spraying method from the prior art, in the present invention the active part is not disassembled before the process begins and no additional openings are made in the tank. The rod element can advantageously be displaced relative to the closure device, in particular by means of a handle attached to the rod element. The rod element can moreover be designed as a mechanically flexible and hence deformable tube, in particular with a swan-neck shape.

After the insulating oil has been drained, a number of radiators are removed from the tank of the transformer. The radiators are preferably those arranged directly in front of and between the windings. The throttle valves to which the radiators in the tank are fastened can now be used for attaching the spraying lances. The spraying devices are screwed onto the throttle valves and carefully pointed towards the windings. The positions of the nozzles of the spraying devices are chosen such that the emitted oil is sprayed accurately onto the windings.

The spraying devices are preferably attached to the upper throttle valves. The lower throttle valves are closed by blank flanges, as long as no other spraying devices are fitted. In the order of the individual processes, an LFH system, a frequency converter or a source of direct current for generating low-frequency electrical currents or direct current, a vacuum pump with a set of valves, and an oil processing system are connected. After the preparatory operations, the method according to the present invention is started. The active part is heated, on the one hand, “from inside” by heating up the windings and the core using the low-frequency current, and “from outside” by spraying warm oil which flows over the insulation and the windings, and washes around the lower yoke. The combined process effects an essentially uniform heating up of the windings and insulation, and parts of the windings are prevented from overheating and the insulation from being burnt locally. As two sources of energy are used, the heating phase is sped up and hence the whole process. The individual systems can be given smaller dimensions as both systems simultaneously supply power for drying the active part. These combined individual systems are therefore suited to on-site repairs and servicing.

After the process has been completed, the tank of the transformer is filled with dry air. The spraying devices are then disassembled and the radiators removed. In most cases, there is no need to re-tension the windings as this drying process is not a hard one, i.e. does not stress the material.

In a last phase, a vacuum is created in the tank and the insulating oil is refilled. After the required oil circuits and the voltage-dependent rest time, measures to bring the transformer back online can be begun.

In an advantageous embodiment of the method, it is provided that the nozzle can be pointed directly at the winding by changing the position and/or length and/or angle of the rod element of the spraying device. In contrast to conventional methods that generate a mist of oil droplets inside the tank, by means of the present invention the winding is sprayed with hot oil in a targeted fashion by means of the spraying device. Because the winding is sprayed directly with a heated oil, the winding is effectively and comprehensively surrounded by a mist of oil droplets. Localized overheated portions and hence possible damage to the insulating layer is hereby prevented. Furthermore, as a result of introducing the hot oil directly in the vicinity of the winding and the associated absorption of water, an effective absorption of the moisture in the mist of oil droplets and a subsequent extraction of the moisture is ensured.

It is seen to be advantageous that the rod element is introduced into an already existing opening in the container, in particular a radiator throttle valve, and the opening is closed gastightly by a closure element. Additional holes are often created in the tank wall as part of the conventional oil spraying method. This is only possible by means of extensive welding work which results, on the one hand, in cost-intensive working and, on the other hand, in a reduced mechanical structure of the tank. Even after subsequent welding of the openings so formed, the mechanical strength of the tank wall is reduced in this region. By virtue of the possibility of targeted positioning of the nozzle of the spraying device by means of the rod element, formerly unused existing openings inside a transformer tank can also be used within the scope of the present invention. In particular, the use of radiator throttle valves has the advantage that the radiators associated with the throttle valves can be removed quickly and simply and a corresponding spraying device can easily be introduced into these already existing openings. For this purpose, the spraying device has a closure element corresponding to the respective opening and which seals the respective opening gastightly, and in this respect permits a comprehensive and effective drying process.

In an advantageous embodiment of the method, it is provided that a control means controls the low-frequency current inside the winding and/or the temperature and/or the spraying rate of the sprayed oil of the spraying device. As a result of the controlling, coordinated by the control means, of the inner heating of the winding by virtue of the LFH method and the targeted introduction of an oil that has been heated in a defined fashion directly onto the winding, gentle drying of the winding on all sides within the scope of the present invention can be ensured. The temperature and moisture distributions inside the tank and the successful removal of moisture within the vacuum cycle can be determined in particular by means of temperature and/or moisture sensors inside the transformer tank, and moisture sensors in the vacuum cycle. Based on these measurement data determined in this way, the control means can ensure the inner heating of the windings with insulating layers and/or of the core by the LFH method. Precise and complete spraying of a mist of oil droplets onto the windings is possible by controlling the temperature and/or the spraying rate of the spraying device.

A plurality of windings are advantageously heated in the container by respectively associated low-frequency currents, and a spraying device is associated with at least one winding, wherein the low-frequency currents inside the winding and/or the temperature and/or the spraying rate of the oil in the spraying device are controlled by the control means. The rod element advantageously has a plurality of nozzles, wherein the temperature and/or spraying rate of the oil which is to be sprayed is controlled by the control means. It is seen to be particularly advantageous that each nozzle of the spraying device can be controlled separately by the control means in terms of temperature and/or spraying rate, so that a defined mist of oil droplets can be generated about the winding.

The object is also achieved by the features according to the invention of a spraying device having a nozzle, by a rod element being provided for positioning the nozzle arranged on the rod element and pointing it at the winding. By means of the design of a spraying device as a rod element having a nozzle arranged on the rod element, the nozzle can be positioned precisely relative to the winding by means of the spraying device.

In an advantageous embodiment of the spraying device, it is provided that the rod element comprises telescopic segments. By virtue of the use of telescopic segments, the nozzle can be positioned precisely along the longitudinal axis of the spraying device. It is furthermore advantageously provided that the rod element has at least two rod segments, wherein the rod segments can be arranged relative to one another by a joint element, in particular an electrically or mechanically controllable linkage, at a pre-determinable angle. The linkage within the sense of the invention can have two degrees of freedom or also be configured as a ball joint such that three degrees of freedom of the movement of the rod elements relative to one another are possible.

A plurality of nozzles are advantageously attached to the rod element and can be controlled individually. The nozzles can be attached either along an individual rod element or on different rod segments which may possibly be moved relative to one another. A closure element advantageously serves to close an opening in the container gastightly.

In an advantageous embodiment of the spraying device, it is provided that the length, position and/or shape of the rod element can be altered by electrically or mechanically controlling the telescopic segments and/or rod segments and/or the joint elements. Changing the diameter of the rod element and/or the telescopic or rod segments can also be used within the sense of the present invention in order to position the nozzles inside the tank in such a way that a uniform mist of oil droplets completely enclosing at least part of the winding is generated.

A detection means, in particular a camera, is advantageously arranged so as to precisely point and position the nozzle on the rod element. Remote ultrasound measurement using a source of ultrasound and a corresponding ultrasound emitter is also conceivable. The detection means can be used to control whether the nozzle is optimally oriented with respect to the winding.

In an advantageous embodiment of the invention it is also provided that the rod element can have a modular construction in terms of the rod segments and/or telescopic segments and/or the joint element. Different rod or telescopic segments can be assembled, in particular by means of a plug-in and screw-in connection or a revolver closure, to form a spraying device which is individually adapted to the respective transformer. Furthermore, an effective pointing of the nozzle or nozzles at the winding can be ensured with correspondingly arranged joint elements.

Further advantageous embodiments can be found in the subclaims. The present invention is explained in more detail with the aid of the attached drawings, in which:

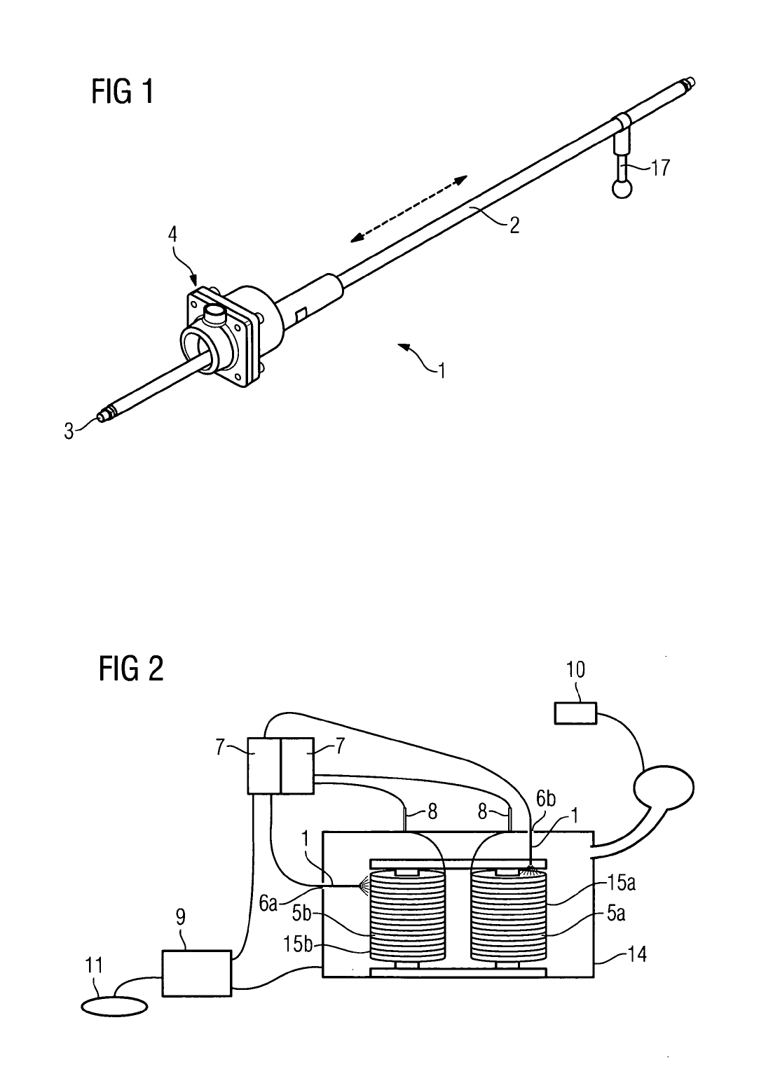

FIG. 1 shows a perspective view of the spraying device;

FIG. 2 shows a schematic side view of a tank with two attached spraying devices and control means;

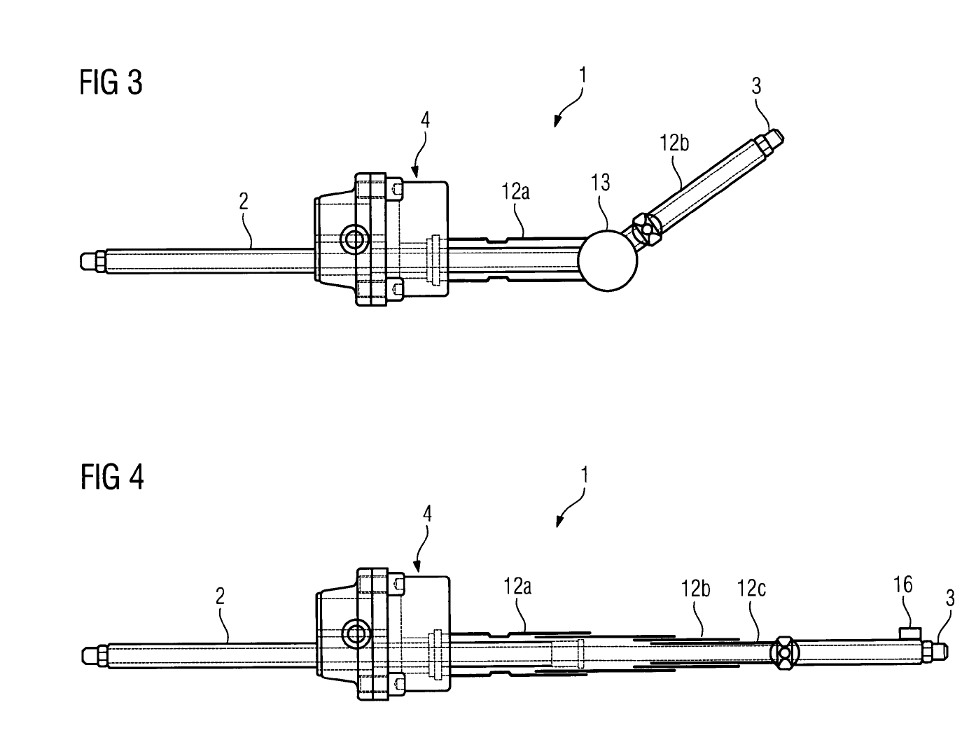

FIG. 3 shows a cross-section of the spraying device having a joint element;

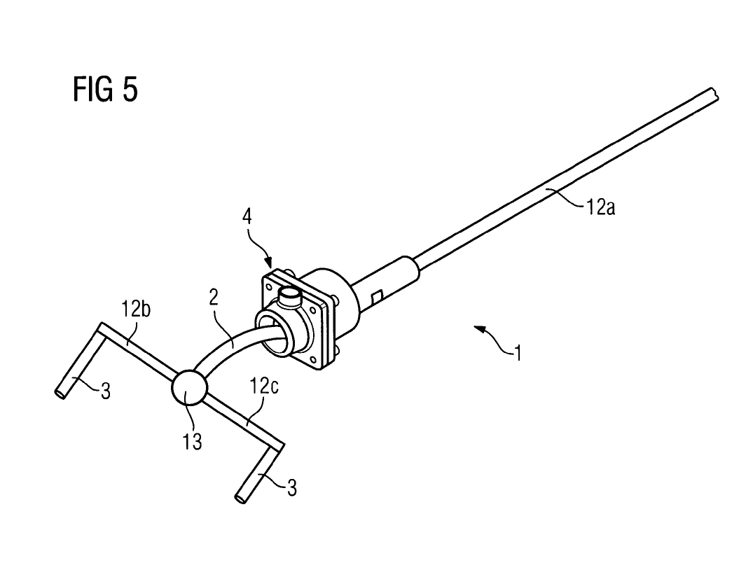

FIG. 4 shows a cross-section of the spraying device having three telescopic segments;

FIG. 5 shows a perspective view of the spraying device having three segments and two nozzles.

FIG. 1 shows a perspective view of the spraying device 1. The spraying device 1 has a rod element 2 which can be pushed through the opening 6a, 6b (not shown) of a container 14 (not shown). A nozzle 3, through which a hot oil can be sprayed, is arranged on the front side of the spraying device 1. The spraying device 1 moreover has a closure element 4 which closes the respective opening 6a, 6b of a container 14 gastightly. The rod element 2 can be adjusted with respect to the closure element 4, a handle 17 serving to adjust the rod element 2 relative to the closure element 4 in the example shown in FIG. 1. The hot oil which is to be sprayed can be introduced inside the rod element 2 under pressure and can be sprayed in a targeted fashion via the nozzle 3 in terms of the pressure control and temperature.

FIG. 2 shows a schematic side view of a tank 14 with two attached spraying devices 1 and a control means 7. In the example shown in FIG. 2, the windings 5a, 5b and the insulating layers 15a, 15b arranged around the respective winding are sprayed inside the tank 14 in a heat mist of oil droplets by two spraying devices 1. The spraying devices 1 can be pushed inside the tank 14 by means of openings 6a, 6b present in the tank 14. The temperature and/or spraying rate of the spraying devices 1 is controlled by a control means 7. In the example shown in FIG. 2, an oil processing unit 9 sucks out the insulating oil situated in the tank 14, wherein the oil processing unit 9 separates the insulating oil content and the moisture content. The moisture content is collected in a corresponding collection tank 11. The insulating oil processed in this way is used for spraying by the spraying devices 1. Other oils or heated kerosene can also alternatively be used for spraying via the spraying devices 1. The control means 7 thus controls, on the one hand, the low-frequency current inside the windings 5a, 5b which flows through the electrical connections 8, as well as the temperature and/or spraying rate of the spraying devices 1. The interior of the tank 14 is evacuated by a vacuum pump 10 so that the moisture content can be reduced to a desired level inside the tank 14.

FIG. 3 shows a cross-section of the spraying device 1 with a joint element 13. Two rod segments 12a, 12b can be angled relative to each other by means of the joint element 13. The joint element 13 can here either have two degrees of freedom so that, for example, motion within the plane of the drawing in FIG. 3 is possible. It is, however, also conceivable that the joint element 13 represents a ball joint and the first rod segment 12a can have a different angle relative to the second rod segment 12b in three dimensions. The oil ducts leading to the nozzle 3 are indicated inside the rod element 2.

FIG. 4 shows a cross-section of the spraying device 1 with three telescopic segments 12a, 12b, 12c. The telescopic segments 12a, 12b, 12c can be pushed into one another so that the length of the rod element 2 and hence of the spraying device 1 can be changed. The telescopic segments 12a, 12b, 12c can advantageously be displaced electrically relative to one another. It is hereby possible for the telescopic segments 12a, 12b, 12c also to be extended inside the tank 14 (not shown). It is here provided that a detection means 16, in particular a camera, can be installed at a point of the rod element 2. It is hereby possible to detect the precise position of the nozzle 3 inside the container 14 and to point it directly at the windings 5a, 5b (not shown).

FIG. 5 shows a perspective view of the spraying device 1 with three rod segments 12a, 12b, 12c which are joined to one another by a joint element 13. One of the rod segments 12a is designed as a mechanically flexible tube that is curved slightly upward in the example shown in FIG. 5. It is thus possible to specify a shape of the rod element 2 or the rod segments 12a, 12b, 12c which is adapted to the respective circumstances. These tubes, also known as a swan neck, can, on the one hand, be mechanically deformed and retain the shape that has been specified for them, unless excessively large forces act on the flexible tube. The rod element 2 of the spraying device 1 according to the example in FIG. 5 has two nozzles 3 which generate a mist of oil droplets either in a coordinated fashion or independently. It is hereby possible to generate a uniform mist of oil droplets which completely surrounds the windings 5a, 5b (also not shown). In conjunction with the heating of the winding 5a, 5b by means of a low-frequency current, a coordinated “internal” and “external” drying of the windings 5a, 5b and the insulating layer 15a, 15b (not shown) is thus possible. At the same time, the winding 5a, 5b and the insulating layer 15a, 15b are dried in a way which protects the material, and the moisture is simultaneously effectively and quickly removed from the transformer.

1-16. (canceled)

17. A method for reducing the moisture of at least one winding surrounded by an insulating layer in a container, the method comprising the following steps:
heating the at least one winding to a pre-determinable temperature with a low-frequency current;
placing a rod element with a nozzle in at least one opening of the container as a spraying device;
pointing the nozzle of the spraying device at the at least one winding;
spraying a heated oil through the nozzle of the spraying device onto the at least one winding; and
completely and gently drying the at least one winding through a combined heating by the low-frequency current and spraying by the spraying device.

18. The method according to claim 17, which further comprises pointing the nozzle directly at the at least one winding by changing at least one of a position or a length or an angle of the rod element relative to a spraying direction.

19. The method according to claim 17, which further comprises carrying out the step of placing the rod element in at least one opening by introducing the rod element into an already existing opening in the container, and gas-tightly closing the opening with a closure element.

20. The method according to claim 17, which further comprises carrying out the step of placing the rod element in at least one opening by introducing the rod element into a radiator throttle valve, and gas-tightly closing the opening with a closure element.

21. The method according to claim 17, which further comprises controlling at least one of the low-frequency current inside the at least one winding or a temperature or a spraying rate of the sprayed oil of the spraying device with a control device.

22. The method according to claim 21, which further comprises:
providing the at least one winding as a plurality of windings;
heating the plurality of windings in the container with respectively associated low-frequency currents;
assigning the spraying device to at least one of the windings; and
controlling at least one of the low-frequency current inside the windings or the temperature or the spraying rate of the oil in the spraying device, with the control device.

23. The method according to claim 21, which further comprises providing the rod element with a plurality of nozzles, and controlling at least one of the temperature or the spraying rate of the oil to be sprayed, with the control device.

24. A spraying device, comprising:
a nozzle for reducing moisture in at least one winding, surrounded by an insulating layer, in a container; and
a rod element carrying said nozzle and allowing said nozzle to be positioned and pointed at said at least one winding.

25. The spraying device according to claim 24, wherein said rod element has telescopic segments.

26. The spraying device according to claim 24, wherein said rod element has at least two rod segments and a joint element for configuring said at least two rod segments relative to one another at a pre-determinable angle.

27. The spraying device according to claim 26, wherein said joint element is an electrically or mechanically controllable linkage.

28. The spraying device according to claim 24, wherein said nozzle is one of a plurality of nozzles attached to said rod element and configured to be controlled individually.

29. The spraying device according to claim 24, which further comprises a closure element for gas-tightly closing an opening in the container.

30. The spraying device according to claim 25, wherein said telescopic segments are configured to be electrically or mechanically controlled for altering at least one of a length, a position or a shape of said rod element.

31. The spraying device according to claim 26, wherein at least one of said rod segments or said joint element are configured to be electrically or mechanically controlled for altering at least one of a length, a position or a shape of said rod element.

32. The spraying device according to claim 24, which further comprises a detection device aiding in precisely pointing and positioning said nozzle on said rod element.

33. The spraying device according to claim 32, wherein said detection device is a camera.

34. The spraying device according to claim 24, wherein said rod element has a modular construction of said rod segments.

35. The spraying device according to claim 24, wherein said rod element has a modular construction of at least one of said telescopic segments or said joint element.

36. The spraying device according to claim 24, which further comprises at least one of at least one temperature or at least one moisture sensor disposed on said rod element.

37. A method for reducing the moisture of at least one winding surrounded by an insulating layer in a container, the method comprising the following steps:
heating the at least one winding to a pre-determinable temperature with a low-frequency current;
placing said rod element with said nozzle of the spraying device according to claim 24 in at least one opening of the container;
pointing the nozzle of the spraying device at the at least one winding;
spraying a heated oil through the nozzle of the spraying device onto the at least one winding; and
completely and gently drying the at least one winding through a combined heating by the low-frequency current and spraying by the spraying device.
